(19) United States
(12) Patent Application Publication
(10) Pub. No.: US 2016/0025609 A1
(43) Pub. Date: Jan. 28, 2016

(54) Method of Acquiring Viscosity of A Downhole Fluid in A Downhole Tool with A Vibrating Wire Viscometer

(71) Applicant: Schlumberger Technology Corporation, Sugar Land, TX (US)

(72) Inventors: Michael Stangeland, Princeton, NJ (US); Yohei Kajikawa, Machida-shi (JP); Yoko Morikami, Sagamihara-shi (JP)

(21) Appl. No.: 14/809,261

(22) Filed: Jul. 26, 2015

Related U.S. Application Data
(60) Provisional application No. 62/030,032, filed on Jul. 28, 2014.

(51) Int. Cl. G01N 11/16; E21B 49/08

(52) U.S. Cl. CPC G01N 11/16; E21B 49/08; E21B 2049/085

(57) ABSTRACT

A method of acquiring viscosity of a downhole fluid is provided. The downhole fluid is in a downhole tool positionable in a wellbore penetrating a subterranean formation. The method involves obtaining a viscosity signal of the downhole fluid using a vibrating wire viscometer of the downhole tool, and acquiring viscosity parameters of the viscosity signal. The acquiring involves adjusting the viscosity signal by removing offsets from the viscosity signal, generating a complex signal from the adjusted viscosity signal, obtaining a low frequency component of the complex signal by filtering the complex signal into a high frequency component and the low frequency component and removing the high frequency component, and determining the viscosity parameters from the low frequency component.

### BACKGROUND

The present disclosure relates generally to wellsite operations. In particular, the present disclosure relates to downhole methods and apparatuses, such as vibrating wire viscometers used for acquiring viscosity of downhole fluids.

The present disclosure relates generally to wellsite operations. In particular, the present disclosure relates to downhole methods and apparatuses, such as viscometers used for acquiring viscosity of downhole fluids.

Wellbores are drilled to locate and produce hydrocarbons. A downhole drilling tool with a bit at an end thereof is advanced into the ground to form a wellbore. As the drilling tool is advanced, drilling mud is pumped through the drilling tool and out the drill bit to cool the drilling tool and carry away cuttings. The fluid exits the drill bit and flows back up to the surface for recirculation through the drilling tool. The drilling mud is also used to form a mudcake to line the wellbore.

During a drilling operation, various downhole evaluations may be performed to determine characteristics of the wellbore and surrounding formations. In some cases, the drilling tool may be provided with devices to test and/or sample the surrounding formation and/or fluid contained in reservoirs therein. In some cases, the drilling tool may be removed and a downhole wireline tool may be deployed into the wellbore to test and/or sample the formation. These samples or tests may be used, for example, to determine whether valuable hydrocarbons are present.

Formation evaluation may involve drawing fluid from the formation into the downhole tool for testing and/or sampling. Various devices, such as probes or packers, may be extended from the downhole tool to establish fluid communication with the formation surrounding the wellbore and to draw fluid into the downhole tool. Downhole tools may be provided with fluid analyzers and/or sensors, such as viscometers, to measure downhole parameters, such as fluid properties. Examples of downhole devices are provided in Patent/Publication Nos. EP2282192, U.S. Pat. No. 7,194,902, U.S. Pat. No. 7,222,671, U.S. Pat. No. 7,458,252, U.S. Pat. No. 8,307,698, U.S. Pat. No. 8,322,196, US2010/0241407, US2011/0023587, US2011/0030455 and US2011/0083501, and in Sullivan et al., “On The Non-Linear Interpretation of a Vibrating Wire Viscometer Operated at Large Amplitude,” Science Direct, Fluid Phase Equilibria vol. 276, pp. 99-107 (2009) (hereafter the “Viscometer Publication”), the entire contents of which are hereby incorporated by reference herein.

### SUMMARY

In at least on aspect, the present disclosure relates to a method of acquiring viscosity of a downhole fluid in a downhole tool. The downhole tool is positionable in a wellbore penetrating a subterranean formation. The method involves obtaining a viscosity signal of the downhole fluid using a vibrating wire viscometer of the downhole tool and acquiring viscosity parameters of the viscosity signal. The acquiring involves selectively adjusting the viscosity signal by removing offsets from the viscosity signal, generating a complex signal from the adjusted viscosity signal, obtaining a low frequency component of the complex signal by filtering the complex signal into a high frequency component and the low frequency component and removing the high frequency component, and determining the viscosity parameters from the low frequency component.

In another aspect, the disclosure relates to a method of acquiring viscosity of a downhole fluid in a downhole tool. The downhole tool is positionable in a wellbore penetrating a subterranean formation. The method involves deploying the downhole tool with a vibrating wire viscometer into the wellbore, drawing fluid into the downhole tool and to the viscometer, obtaining a viscosity signal from the viscometer, and acquiring viscosity parameters of the viscosity signal. The acquiring involves selectively adjusting the viscosity signal by removing offsets from the viscosity signal, generating a complex signal from the adjusted viscosity signal, obtaining a low frequency component of the complex signal by filtering the complex signal into a high frequency component and the low frequency component and removing the high frequency component, and determining the viscosity parameters from the low frequency component.

Finally, in another aspect, the disclosure relates to a method of acquiring viscosity of a downhole fluid in a downhole tool. The downhole tool is positionable in a wellbore penetrating a subterranean formation. The method involves obtaining a viscosity signal from a vibrating wire viscometer of the downhole tool, acquiring viscosity parameters of the viscosity signal, and selectively providing voltage to the viscometer based on the determined viscosity parameters. The acquiring involves selectively adjusting the viscosity signal by removing offsets from the viscosity signal, generating a complex signal from the adjusted viscosity signal, obtaining a low frequency component of the complex signal by filtering the complex signal into a high frequency component and the low frequency component and removing the high frequency component, and determining the viscosity parameters from the low frequency component.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Embodiments of the downhole viscosity measurement method are described with reference to the following figures. The same numbers are used throughout the figures to reference like features and components.

FIGS. 1.1 and 1.2 are schematic views, partially in cross-section, illustrating a wellsite with a downhole drilling tool and a downhole wireline tool, respectively, deployed into a wellbore for measuring viscosity of downhole fluids;

FIG. 2.1 is a schematic view illustrating a portion of a downhole tool having a formation evaluation tool with a vibrating wire viscometer;

FIG. 2.2 is a schematic view illustrating a vibrating wire viscometer obtaining a viscosity signal;

FIG. 3 is a flow chart illustrating a method of acquiring viscosity of a downhole fluid;

FIG. 4 is a graph illustrating a complex signal generated from the viscosity signal;

FIGS. 5.1 and 5.2 are graphs illustrating frequencies of the viscosity signal and the complex signal before and after filtering, respectively;

FIG. 6 is a graph illustrating filtered signals generated from the complex signal; and

FIGS. 7.1-7.2 are graphs illustrating phase and magnitude, respectively, of the filtered signals.

### DETAILED DESCRIPTION

The description that follows includes exemplary apparatuses, methods, techniques, and instruction sequences that embody techniques of the inventive subject matter. However, it is understood that the described embodiments may be practiced without these specific details.

The present disclosure relates to methods for acquiring viscosity of a downhole fluid using a vibrating wire viscometer. A downhole tool with the viscometer therein may be deployed into a wellbore to obtain a viscosity signal from downhole fluid drawn into the downhole tool. The viscosity signal may be adjusted, trimmed, filtered, and otherwise manipulated to obtain viscosity parameters, such as amplitude, frequency, decrement, and phase of the signal. The viscosity parameters (e.g., frequency) may be selected to define an optimal frequency for exciting the viscometer during operation.

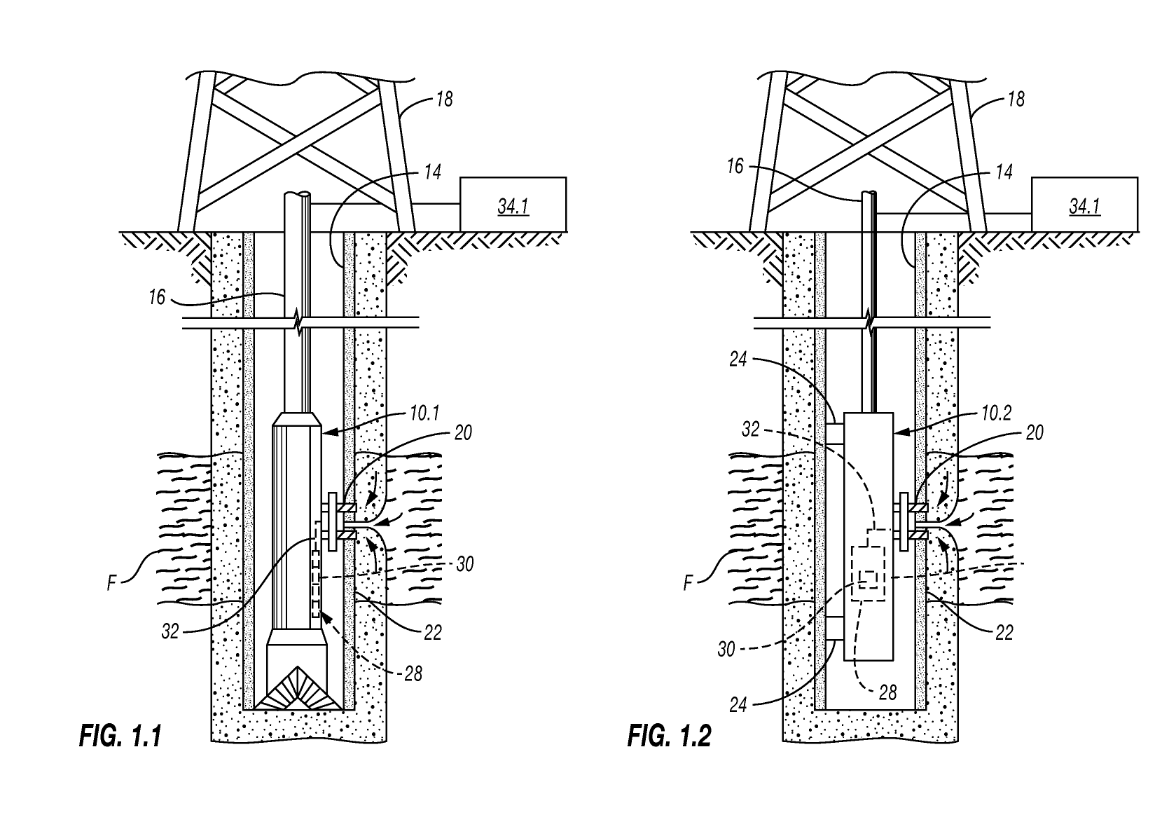

FIGS. 1.1 and 1.2 depict environments in which subject matter of the present disclosure may be implemented. FIG. 1.1 depicts a downhole drilling tool 10.1 and FIG. 1.2 depicts a downhole wireline tool 10.2 that may be used for performing formation evaluation. The downhole drilling tool 10.1 may be advanced into a subterranean formation F to form a wellbore 14. The downhole drilling tool 10.1 may be conveyed alone or among one or more (or itself may be) measurement-while-drilling (MWD) drilling tools, a logging-while-drilling (LWD) drilling tools, or other drilling tools. The downhole tool 10.1 is attached to a conveyor (e.g., drillstring) 16 driven by a rig 18 to form the wellbore 14. The downhole tool 10.1 includes a probe 20 adapted to seal with a wall 22 of the wellbore 14 to draw fluid from the formation F into the downhole tool 10.1 as depicted by the arrows.

The downhole drilling tool 10.1 may be withdrawn from the wellbore 14, and the downhole wireline tool 10.2 of FIG. 1.2 may be deployed from the rig 18 into the wellbore 14 via conveyance (e.g., a wireline cable) 16. The downhole wireline tool 10.1 is provided with the probe 20 adapted to seal with the wellbore wall 22 and draw fluid from the formation F into the downhole tool 10.2. Backup pistons 24 may be used to assist in pushing the downhole tool 10.2 and probe 20 against the wellbore wall 22 and adjacent the formation F.

The downhole tools 10.1, 10.2 may also be provided with a formation evaluation tool 28 with a viscometer 30 for measuring downhole parameters. The formation evaluation tool 28 includes a flowline 32 for receiving the formation fluid from the probe 20 and passing the fluid to the viscometer 30 for measurement as will be described more fully herein. A surface unit 34.1 may be provided to communicate with the downhole tool 10.1, 10.2 for passage of signals (e.g., data, power, command, etc.) therebetween.

While FIGS. 1.1 and 1.2 depict specific types of downhole tools 10.1 and 10.2, any downhole tool capable of performing formation evaluation may be used, such as drilling, coiled tubing, wireline or other downhole tool. Also, while FIGS. 1.1 and 1.2 depict the formation evaluation tool 28 in a wellbore 14, it will be appreciated that the formation evaluation tool 28 and/or viscometer 30 may be used at a surface and/or downhole location at the wellsite, and/or at an offsite facility for measuring fluid parameters.

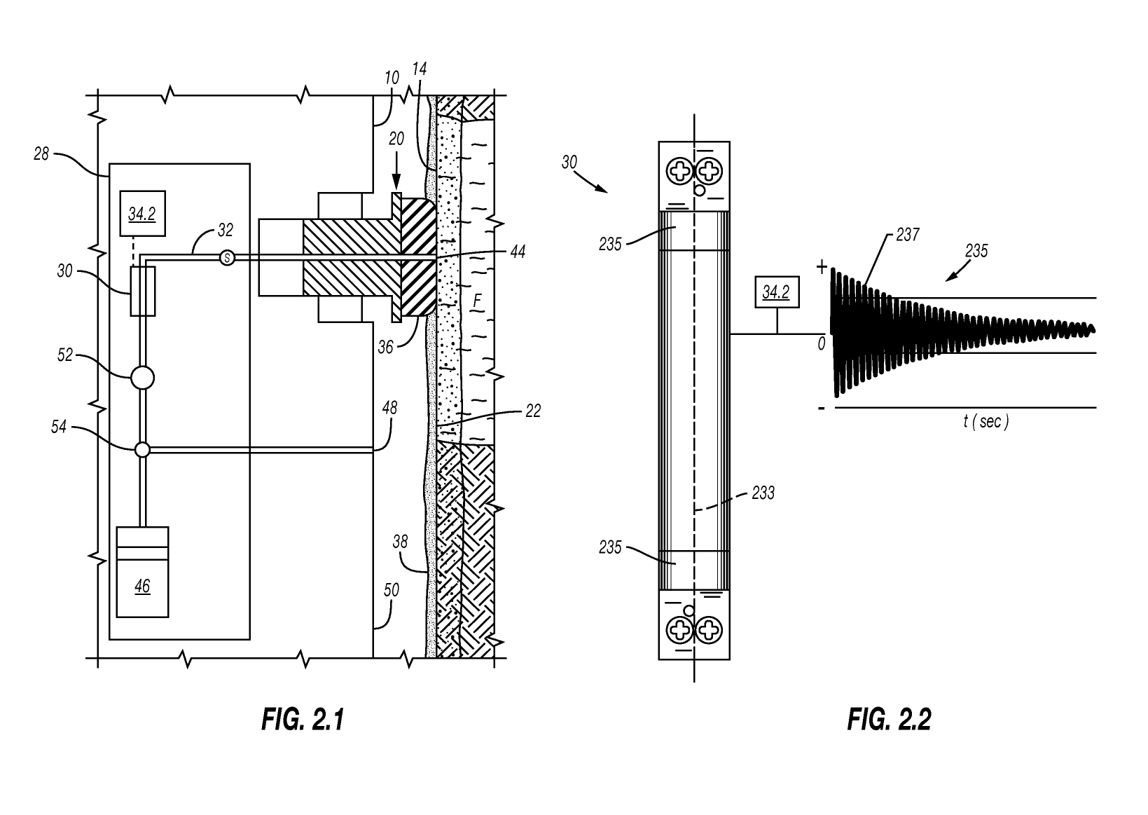

FIG. 2.1 depicts portions of the downhole tool 10, which may be either of the downhole tools 10.1 or 10.2 of FIG. 1.1 or 1.2. FIG. 2.1 shows a portion of the downhole tool depicting the formation evaluation tool 28, viscometer 30, and viscosity unit 34.2 therein. FIG. 2.2 depicts the viscometer 30 in greater detail with an example output 235 generated therefrom.

As shown in FIG. 2.1, the probe 20 may be extended from the downhole tool 10 for engagement with the wellbore wall 22. The probe 20 is provided with a packer 36 for sealing with the wellbore wall 22. Packer 36 contacts the wellbore wall 22 and forms a seal with a mudcake 38 lining the wellbore wall 22.

The formation evaluation tool 28 may be provided with one or more flowlines 32 for drawing fluid into the downhole tool 10 through an inlet 44 in the probe 20. While one probe 20 with one inlet 44 is depicted, one or more probes, dual packers and related inlets may be provided to receive downhole fluids and pass them to one or more of the flowlines 32. Examples of downhole tools and fluid communication devices, such as probes, that may be used are depicted in U.S. Patent/Application No. U.S. Pat. No. 7,458,252, previously incorporated herein.

A sample chamber 46 is also coupled to the flowline 32 for receiving the downhole fluid. Fluid collected in the sample chamber 46 may be collected therein for retrieval at the surface, or may be exited through an outlet 48 in housing 50 of the downhole tool 10. Optionally, flow of the downhole fluid into and/or through the downhole tool 10 may be manipulated by one or more flow control devices, such as a pump 52, the sample chamber 46, valve 54 and/or other devices.

The flowline 32 extends into the downhole tool 10 to pass downhole fluid to the formation evaluation tool 28. The formation evaluation tool 28 may be used to analyze, test, sample and/or otherwise evaluate the downhole fluid. One or more sensors S may optionally be provided to measure various downhole parameters and/or fluid properties. The sensor(s) S may include, for example, gauges (e.g., quartz), densitometers, viscometers, resistivity sensors, nuclear sensors, and/or other measurement and/or detection devices capable of taking downhole data relating to, for example, downhole conditions and/or fluid properties.

The viscometer 30 is positioned in the formation evaluation tool 28 and is coupled to the flowline 32 for receiving the downhole fluid. An example viscometer 30 which may be used is shown in FIG. 2.2. The viscometer 30 may be any downhole vibrating wire viscometer capable of measuring viscosity of downhole fluids. The viscometer 30 includes a metal wire 233 clamped in a magnetic field between permanent magnets 235. Examples of viscometers are provided in EP2282192, U.S. Pat. No. 7,194,902, U.S. Pat. No. 7,222,671, U.S. Pat. No. 8,307,698, U.S. Pat. No. 8,322,196, US2011/0023587, US2011/0030455, US2011/0083501 and the Viscometer Publication, previously incorporated by reference herein.

The viscometer 30 may be used to measure viscosity of the downhole fluid. The viscometer 30 may also be used to generate outputs, such as graph 235 as shown in FIG. 2.2. Data captured using the viscometer 30 may be collected in the viscosity unit 34.2 and/or the surface unit 34.1 (FIGS. 1.1 and 1.2). The graph 235 may be generated using, for example, the viscosity unit 34.2. Graph 235 shows a plot of a measured signal 237 with an output (V) (y-axis) versus time (t) (x-axis) generated from the vibrating wire viscometer 30. The graph 235 depicts attenuation measured by the viscometer 30 when exposed to downhole fluid.

Optionally, the surface unit 34.1 and/or the viscosity unit 34.2 may be provided to communicate with the formation evaluation tool 28, the viscometer 30, and/or other portions of the downhole tool 10 for the passage of signals (e.g., data, power, command, etc.) therebetween. The viscosity unit 34.2 may be used with the viscometer 30, for example, to apply a wave electric voltage on the edges of the wire 233. The voltage may be used to induce an electric current, and generate an electromagnetic force on the wire 233. The voltage may be applied at a given frequency for exciting the wire 233. The mechanical resonance of the wire 233 is excited and attenuated by drag force as the wire 233 is exposed to downhole fluid. The attenuation contains information concerning the viscosity of the downhole fluid.

The viscosity unit 34.2 is usable in collecting, analyzing, processing, controlling, and/or otherwise performing operations relating to the measurement of viscosity of downhole fluids. The viscosity unit 34.2 may be used to generate viscosity parameters, such as frequency (ω), decrement (Δ), amplitude, and phase (Φ), from the viscosity signal received from the viscometer 30.

The downhole tool 10 may also be provided with telemetry means, such as mud pulse, wireline cable, electromagnetic, wired drill pipe, and/or other telemetry, using a telemetry, measurement while drilling, logging while drilling, or other downhole component or tool. The telemetry means may be used to transmit data and/or signals between the viscosity unit 34.2 and the surface unit 34.1 (and/or other locations). Memory may be provided in the viscosity unit 34.2 and/or surface unit 34.1 (FIGS. 1.1 and 1.2) for collecting, processing and/or transferring data at downhole and/or surface locations.

The memory, telemetry and/or communications provided may be used for surface and/or downhole collection, processing, and/or communication of signals and/or data. In an example, a small amount and/or limited amount of memory is provided for wireline tool downhole data processing. In this example, downhole data processing, which imposes limited memory size, provides more frequent measurement interval/response time even with the limited telemetry speed, and may not be needed to transmit data (e.g., the full signal data) to the surface.

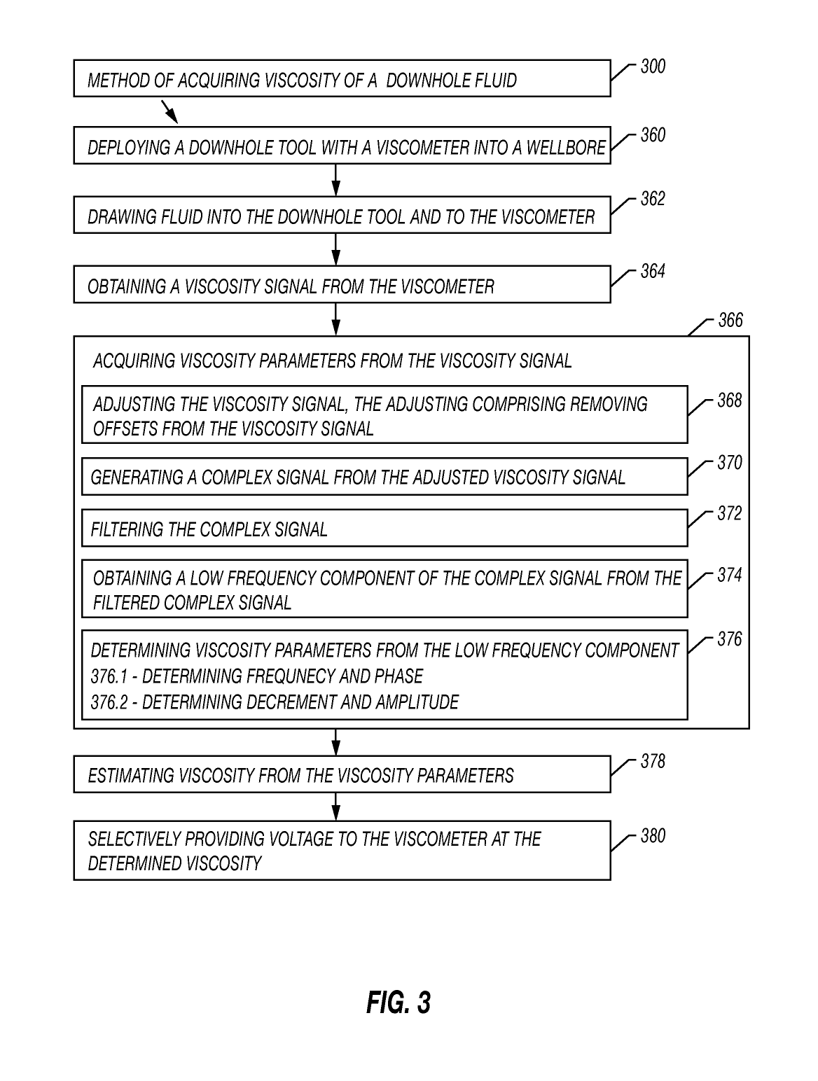

FIG. 3 depicts a flow chart of a method (300) of acquiring viscosity parameters of a downhole fluid. The method 300 of FIG. 3 may be performed using, for example, the equipment as depicted in FIGS. 1.1-2.2. The method 300 may involve 360—deploying a downhole tool with a viscometer into a wellbore. The deploying 360 may be implemented using, for example, the downhole tool 10 and viscometer 30 of FIGS. 1.1-2.2.

The method 300 continues by 362—drawing fluid into the downhole tool and to the viscometer. Fluid may be drawn into the downhole tool 10 through probe 20 and flowline 32. The fluid is then passed to the viscometer 30 for measurement. The method 300 continues by 364—obtaining a viscosity signal from the viscometer. The viscosity signal 237 may be obtained using the viscometer 30 as fluid vibrates the wire 233.

The method 300 continues by 366—acquiring viscosity parameters from the viscosity signal. The acquiring 366 may involve 368—adjusting the viscosity signal (e.g., selectively adjusting the viscosity signal by removing offsets), 370—generating a complex signal from the adjusted viscosity signal, 372—filtering the complex signal, 374—obtaining a low frequency component of the complex signal, and determining 376 viscosity parameters from the low frequency component.

The viscosity parameters may be acquired 366 from the viscosity signal 237. The viscosity signal 237 may be used to generate viscosity parameters, such as amplitude, frequency, decrement, and phase of the signal, among others. The viscosity signal Y(t) may be expressed as a linear damping model as follows:

Y(t)=A×e^{-Δωt} sin (ωt+Φ)+offset Eqn. (1)

where A is the amplitude, ω is the frequency, Δ is the decrement, and Φ is the phase.

The adjusting 368 may be performed, for example, to remove portions of the signal that may affect the resulting viscosity. For example, the signal 237 may involve removing offsets from the viscosity signal 237. Offset of the viscosity signal 237 may be measured separately and may be removed using Eqn. (1) thereby reducing the variables to be solved.

The adjusting may also involve other refinements, such as trimming, filtering, or otherwise adjusting the signal to eliminate error. Trimming may involve, for example, trimming Mₜᵣᵢₘ(t) a bandwidth of the viscosity signal using the following equation:

Mₜᵣᵢₘ(t)=A×e^{Δ}^{_{ref}}^{ω}^{_{ref}}^{t} Eqn.(2)

where A is the amplitude, Δref is the reference decrement, and t is the time. Portions of the viscosity signal may be performed, for example, to trim (or remove) side lobes and/or to tighten side bands of the viscosity signal 237.

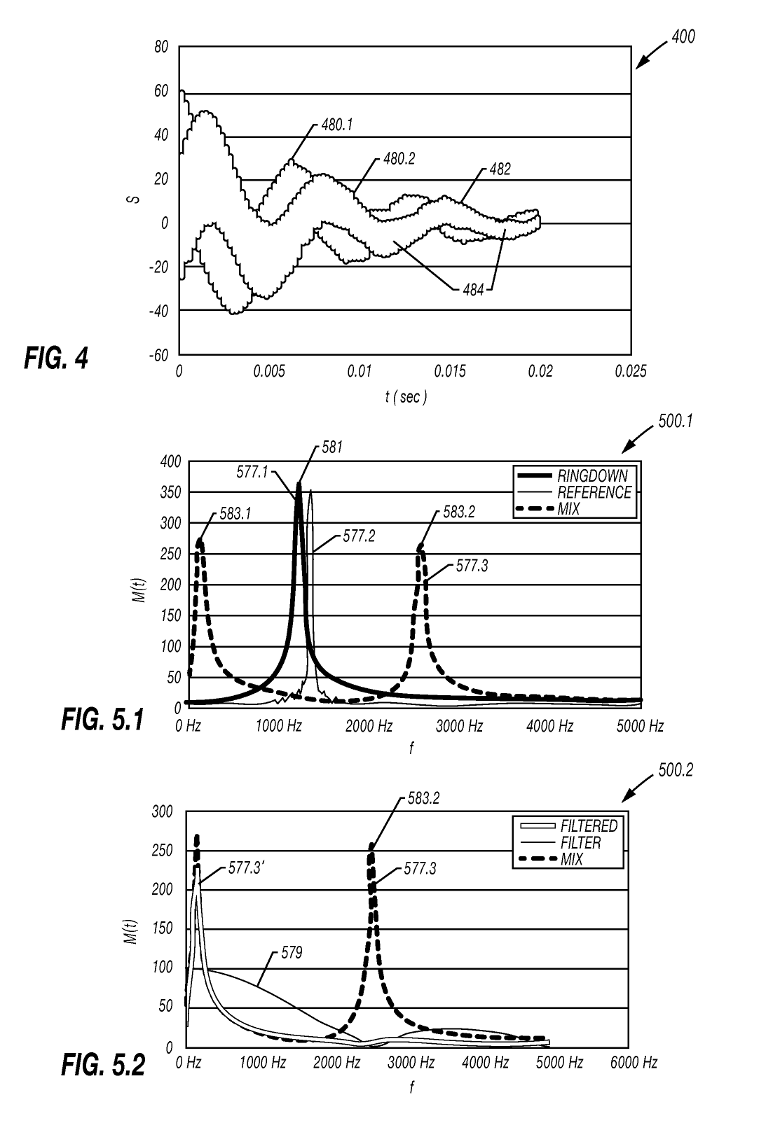

The complex signal may be generated 370 from the adjusted viscosity signal. The generating 370 involves generating a complex signal from the viscosity signal 237 as depicted in the graph 400 of FIG. 4. The graph 400 is a plot of the signal (S) (y-axis) versus time (t) (x-axis). The complex signal includes a real signal 480.1 and an imaginary signal 480.2. Each of the signals 480.1 and 480.2 has high and low frequency components 482, 484 in the form of a plurality of high frequency oscillations therealong.

Reference sine and cosine oscillations of a reference frequency (ω_{ref}) may be used to obtain the complex signal (with real and imaginary components 480.1, 480.2). These components 480.1, 480.2 each contain two main frequencies: 1) high frequency components (ω_{ref}+ω) and 2) low frequency components (ω_{ref}−ω). The complex signal may also be generated by providing high and low frequency components 480.1, 480.2 of the viscosity signal. The reference sine and cosines are expressed as follows:

Rₛᵢₙ(t)=sin (ω_{ref}t) Eqn (3)

R_{cos}(t)=cos (ω_{ref}t) Eqn (4)

The complex signal (as shown in FIG. 4) may be generated by multiplying the input viscosity signal 237 with the trimming Mₜᵣᵢₘ(t) of Eqn. (2) and the reference the sine signal (Rₛᵢₙ(t)) of Eqn. (3) and the reference cosine signal (R_{cos}(t)) of Eqn. (4) as shown in Eqns. (5) and (6) below:

$$\begin{matrix}\begin{matrix}x ( t ) = ( Y ( {t}_{e} ) - offset ) \times Mtrim ( t ) \times R sin ( t ) ( {ω}_{ref} ) \\ = A \times {e}^{( {Δ}_{ref} {ω}_{ref} - Δ ω ) t} sin ( ω t + φ ) sin ( {ω}_{ref} t )\end{matrix} & Eqn . ( 5 ) \\ \begin{matrix}y ( t ) = ( Y ( {t}_{e} ) - offset ) \times Mtrim ( t ) \times R cos ( t ) ( {ω}_{ref} ) \\ = A \times {e}^{( {Δ}_{ref} {ω}_{ref} - Δ ω ) t} sin ( ω t + φ ) cos ( {ω}_{ref} t )\end{matrix} & Eqn . ( 6 )\end{matrix}$$

The signals 480.1, 480.2 have side lobes and side bands depicted as widths of peaks that may be trimmed during the adjusting 368.

The signals 480.1 and 480.2 may be generated from the signals depicted in FIG. 5.1. FIG. 5.1 is a graph 500.1 depicting a frequency curve 577.1 of the original signal 237, the frequency curve 577.2 of a complex reference signal, and the frequency curve 577.3 of the complex signal 400. The graph 500.1 plots magnitude (M(t)) (y-axis) versus frequency (f) (x-axis). The frequency curve 577.1 of the original signal has a maximum or peak 581 that may be used as an estimated frequency. The frequency curve 577.3 has a low frequency peak 583.1 and a high frequency peak 583.2.

The complex reference may contain a complementing decrement to compensate for the decrement in the signal. The reference frequency (ω_{ref}) may be chosen to be a difference between the frequency of the input signal 237 and the frequency of the zero of a low-pass filter. From product-to-sum identities of trigonometric functions, the complex signals may be expressed as follows:

$$\begin{matrix}x ( t ) = \frac{1}{2} A \times {e}^{( {Δ}_{ref} {ω}_{ref} - Δ ω ) t} \{ cos ( ( ω - {ω}_{ref} ) t + φ ) - cos ( ( ω + {ω}_{ref} ) t + φ ) \} & Eqn . ( 7 ) \\ y ( t ) = \frac{1}{2} A \times {e}^{( {Δ}_{ref} {ω}_{ref} - Δ ω ) t} \{ sin ( ( ω - {ω}_{ref} ) t + φ ) - sin ( ( ω + {ω}_{ref} ) t + φ ) \} & Eqn . ( 8 )\end{matrix}$$

where A^{(Δ}^{_{ref}}^{ω}^{_{ref}}^{-Δω)t} is the trimmed decrement, and cos ((ω+ω_{ref})t+Φ) is a location of the peak 583.2 of FIG. 5.1.

The high and low frequency components 482, 484 are also depicted in FIG. 5.1 as the high and the low frequency peaks 583.2 and 583.1, respectively, in the frequency domain. The frequency curve 577.3 of the complex signal of FIG. 5.1 may be generated, for example, from Eqns. (7) and (8). The reference frequency (ω_{ref}) may influence a location of the peak 583.2 of FIG. 5.1. A reference decrement (Δ_{ref}) may be assumed to be a negative of an estimate of the decrement (Δ) of the signal 237.

The filtering 372 may be performed as part of the adjusting, or as a separate operation. The filtering 372 may involve an examination of the frequencies of the signals as depicted in FIGS. 5.1 and 5.2. FIG. 5.2 is a graph 500.2 depicting the frequency curve 577.3 of the complex signal, a filter curve 579, and a filtered frequency curve 577.3′. The graph 500.2 plots magnitude (M(t)) (y-axis) versus frequency (f) (x-axis). The filter frequency curve 577.3′ may depict the filter applied to the frequency curve 577.3 of the complex signal. The filtered frequency curve 577.3′ is a curve generated by passing the frequency curve 577.3 of the complex signal through a filter.

The high frequency oscillations 482 of FIG. 4 are generated by a high frequency peak 583.2 generated from the high frequency component 577.3 of FIG. 5.2. The high frequency oscillations 482 may be filtered from the complex signals 480.1, 480.2 by removing the high frequency peak 583.2 of the frequency curve 577.3 of the complex signals 480.1, 480.2.

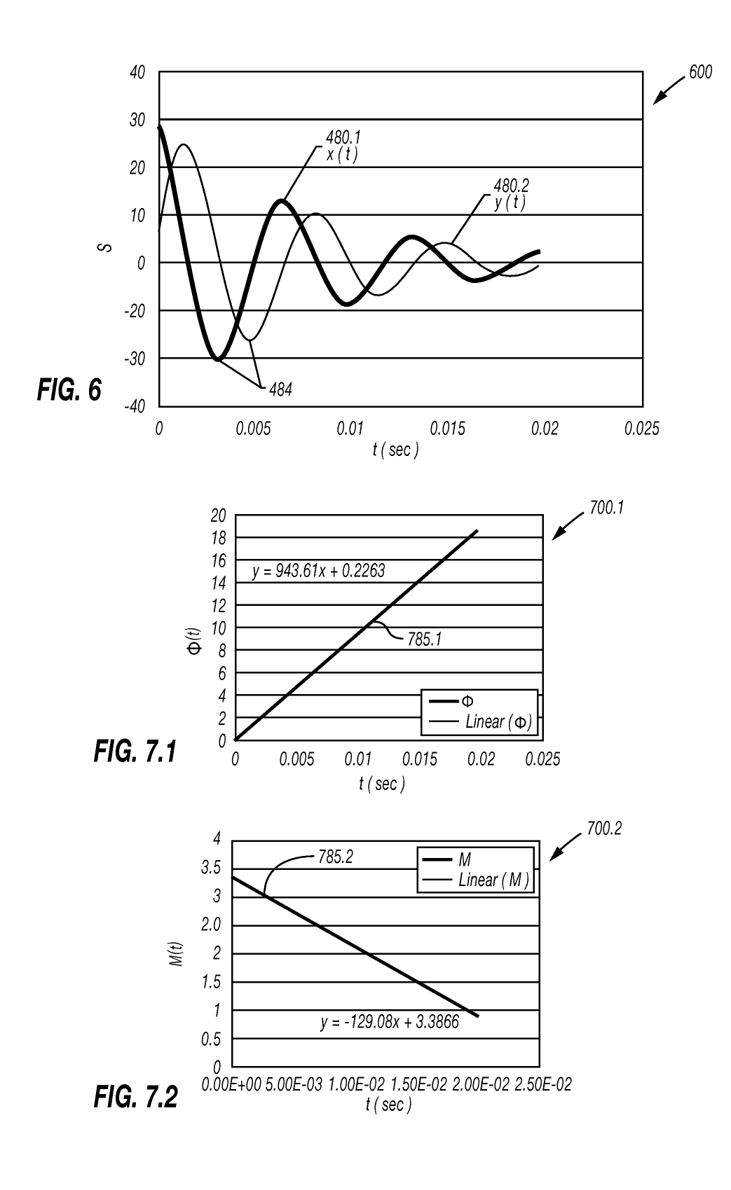

The filtering may involve trimming the high frequency oscillations 482 from the viscosity signals 480.1, 480.2 as shown, for example, in FIG. 4 to generate filtered signals 480.1′, 480.2′ as shown in FIG. 6. FIG. 6 is a graph 600 depicting signal (S) (y-axis) versus elapsed time (t) (x-axis).

The filtering may involve using a low pass digital filter (e.g., a boxcar or triangle filter) which has known notches at specific frequencies. In the case of using such a filter with specific notches/zeros, frequency (ω) may be estimated (ωₑₛₜᵢₘₐₜₑ) and the reference frequency (ω_{ref}) chosen such that the high frequency component (ω_{ref}+ωₑₛₜ) will be located at a zero of the filter. The reference frequency (ω_{ref}) can be selected such that the estimated frequency (ωₑₛₜᵢₘₐₜₑ) and the reference frequency (ω_{ref}) align about the reference signal. In an example case, if the filter can be implemented in real time with zeros at any frequency, and the reference frequency (ω_{ref}) can be set to an estimated frequency (ωₑₛₜᵢₘₐₜₑ).

The high frequency oscillations 482 are represented by the high frequency components (ω+ω_{ref}) in Equations (7) and (8). The high frequency components may be removed by applying the filter. Any filter may be used that is capable of removing a frequency lobe, such as a notch, triangle, or boxcar filter. The filter may be selected to have zeros that can remove the frequency exactly at the high frequency components (ω+ω_{ref}).

In an example using a given filter, each zero of the filters may be double zeros for removal of the side bands of the high frequency components (ω+ω_{ref}). Note that the side bands can be reduced using a box-car filter as follows:

$$H ( j ω ) = {\int }_{- ∞}^{∞} h ( t ) {e}^{- j ω t} d t = \frac{sin ( \frac{NT ω}{2} )}{( \frac{NT ω}{2} )} \qquad Eqn . ( 9 )$$

where j is an imaginary number, h(t) is a frequency response of the filter, N is a number of values being averaged or a length of the filter, and T is a sampling period.

The box-car filter of N elements has N−1 zeros which are located at the following:

$${ω}_{zero} ( n ) = \frac{2 π n}{NT} \qquad Eqn . ( 10 )$$

where n is the number of zeros in the filter.

A second zero (n=2) of the box-car filter may be used. For the second zero to be near 2ωₑₛₜᵢₘₐₜₑ, N may be chosen to be a closest integer number of samples in the signal. The exact frequency at a second zero (ω_{zero}(2)) may be known, and the reference frequency (ω_{ref}) may be determined from an estimate of a previous acquisition (ωₑₛₜᵢₘₐₜₑ) based on the following:

ω_{ref}=ω_{zero}−ωₑₛₜᵢₘₐₜₑ Eqn. (11)

Based on the filtering 372, the low frequency component may be obtained 374. By applying the boxcar filter, the high frequency term can be omitted leaving only the following:

$$\begin{matrix}{x}^{′} ( t ) = \frac{1}{2} A {e}^{( {Δ}_{ref} {ω}_{ref} - ω Δ ) t} cos [ ( ω - {ω}_{ref} ) t + φ ] & Eqn . ( 12 ) \\ {y}^{′} ( t ) = \frac{1}{2} A {e}^{( {Δ}_{ref} {ω}_{ref} - ω Δ ) t} sin [ ( ω - {ω}_{ref} ) t + φ ] & Eqn . ( 13 )\end{matrix}$$

Eqns. (12) and (13) provide the low frequency components x′(t), y′(t). With the high frequency components removed, the low frequency components x′(t), y′(t) of the complex signals 480.1,′ 480.2′ may be depicted as smooth waves 484 (without the oscillations 482 of FIG. 4) as shown in FIG. 6.

Referring back to FIG. 3, the determining 376 viscosity parameters involves determining viscosity parameters from a low frequency component of the filtered complex signal. The viscosity parameters may include frequency and/or other viscosity parameters (e.g., amplitude, decrement, and phase). The determining 374 may involve determining 376.1 the frequency and the phase, and determining 376.2 the decrement and the amplitude.

From the phase (Φ) of x′(t) and y′(t) (collectively a complex value), a phase Φ(t) of the two components x′(t) and y′(t) for each point in time may be determined based on the following:

$$Φ ( t ) = {tan}^{- 1} \{ \frac{{y}^{′} ( t )}{{x}^{′} ( t )} \} = ( ω - {ω}_{ref} ) t + φ \qquad Eqn . ( 14 )$$

The phase Φ(t) generated for each point in time is depicted in FIG. 6.

Frequency (ω) and phase (Φ) of the input signal 237 may be derived from the slope and the intercept of unwrap (Φ(t)) as shown in FIG. 7.1. FIG. 7.1 is a graph 700.1 depicting phase (Φ(t)) (y-axis) versus time (t). In the example shown, the slope y=934.61x+0.2263. FIG. 7.1 may be plotted by unwrapping the phase of the two signals of FIG. 6 and generating a line 785.1 based on a least squares fitting.

The slope of the line 785.1 provides (ω_{ref}−ω), and the y-intercept of the line 785.1 at time t=0 may be used as to define the phase (Φ(t)). The slope and the y-intercept may be determined using line fitting. This line fitting may be performed with data after the point where M(t) reaches the noise floor and before the line turns horizontal. The horizontal data may be excluded from the line fitting. Once the slope and y-intercept are determined, the frequency (ω)) and phase (Φ) may be determined based on Eqn. (14).

The decrement (Δ) and amplitude (A) may be determined from the magnitude (M(t)) of the two components, x′(t) and y′(t), and ω based on the following:

$$M ( t ) = ln \{ \sqrt{{[ {x}^{′} ( t ) ]}^{2} + {[ {y}^{′} ( t ) ]}^{2}} \} = - ω Δ t + ln ( \frac{A}{2} ) \qquad Eqn . ( 15 )$$

Decrement (Δ) and Amplitude (A) of the input signal 237 can be derived from the slope and the intercept of the magnitude (M(t)) as shown in FIG. 7.2. FIG. 7.2 depicts a graph 700.2 with a magnitude (M(t)) (y-axis) versus elapsed time (t) (x-axis). The slope y==129.08x+3.3866. FIG. 7.2 may be plotted from a log of the two signals of FIG. 6 to generate a line 785.2 based on a least squares fitting.

The slope of the line 785.2 provides In (A/2), and the y-intercept of the line 785.2 at time t=0 may be used as to define the magnitude (M(t)). With this information, the decrement (Δ) and amplitude (A) may be determined based on Eqn. (15).

In some examples, the viscosity signal 237 may reduce to zero before acquisition is complete. In cases where viscosity is higher, the graph in FIG. 7.2 may be steep and approach a certain level where the signal and amplitude fall below the signal and amplitude of other components, and become lost. In such cases, the signal 237 may become a horizontal line. Such horizontal portions may represent an absence of information or misinformation, and may be eliminated.

Referring back to FIG. 3, the method 300 may continue by estimating 378—viscosity from the viscosity parameters. The method 300 may also involve 380—selectively providing voltage to the viscometer at the determined frequency. The viscosity parameters may be used to determine a frequency and an amplitude for operation of the viscometer (e.g., 30 of FIGS. 2.1-2.2). The viscometer may be excited at the determined frequency. The frequency may thereby be selected to be an optimal frequency for operation of the viscometer.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method of acquiring viscosity of a downhole fluid in a downhole tool, the downhole tool positionable in a wellbore penetrating a subterranean formation, the method comprising:
obtaining a viscosity signal of the downhole fluid using a vibrating wire viscometer of the downhole tool;
acquiring viscosity parameters of the viscosity signal by:
selectively adjusting the viscosity signal, the selectively adjusting comprising removing offsets from the viscosity signal;
generating a complex signal from the adjusted viscosity signal;
obtaining a low frequency component of the complex signal by filtering the complex signal into a high frequency component and the low frequency component and removing the high frequency component; and
determining the viscosity parameters from the low frequency component.

2. The method of claim 1, wherein the adjusting comprises trimming portions of the viscosity signal.

3. The method of claim 1, wherein the generating the complex signal comprises generating a real signal and an imaginary signal from reference sine and cosine oscillations of the viscosity signal.

4. The method of claim 1, wherein the filtering comprises using a low pass digital filter comprising at least one of a boxcar, a notch, and a triangle filter.

5. The method of claim 1, further comprising determining the viscosity from the viscosity parameters.

6. The method of claim 5, further comprising determining an estimated frequency and an amplitude from the determined viscosity.

7. The method of claim 6, further comprising selectively providing voltage to the viscometer according to the determined frequency and amplitude.

8. The method of claim 1, wherein the acquiring viscosity parameters comprises acquiring at least one of frequency, decrement, amplitude and phase of the viscosity signal.

9. The method of claim 1, wherein the determining the viscosity parameters comprises determining frequency and phase by unwrapping a phase of the filtered complex signals, generating a best fit line, and determining a slope and y-intercept of the best fit line.

10. The method of claim 1, wherein the determining viscosity parameters comprises determining decrement and amplitude by generating a log of the filtered complex signals, generating a best fit line, determining a slope and y-intercept of the best fit line, and generating a magnitude of the filtered complex signals.

11. A method of acquiring viscosity of a downhole fluid in a downhole tool, the downhole tool positionable in a wellbore penetrating a subterranean formation, the method comprising:
deploying the downhole tool with a vibrating wire viscometer into the wellbore;
drawing fluid into the downhole tool and to the viscometer;
obtaining a viscosity signal from the viscometer;
acquiring viscosity parameters of the viscosity signal by:
selectively adjusting the viscosity signal, the selectively adjusting comprising removing offsets from the viscosity signal;
generating a complex signal from the adjusted viscosity signal;
obtaining a low frequency component of the filtered complex signal by filtering the complex signal into a high frequency component and the low frequency component and removing the high frequency component; and
determining the viscosity parameters from the low frequency component.

12. The method of claim 11, further comprising collecting samples of the downhole fluid.

13. The method of claim 11, further comprising collecting data from the viscometer.

14. The method of claim 11, further comprising collecting the viscosity signal in one of a surface unit and a viscosity unit.

15. The method of claim 11, wherein the acquiring a viscosity signal comprises applying a voltage to a wire of the viscometer and measuring the viscosity signal therefrom.

16. A method of acquiring viscosity of a downhole fluid in a downhole tool, the downhole tool positionable in a wellbore penetrating a subterranean formation, the method comprising:
obtaining a viscosity signal from a vibrating wire viscometer of the downhole tool;
acquiring viscosity parameters of the viscosity signal by:
selectively adjusting the viscosity signal, the selectively adjusting comprising removing offsets from the viscosity signal;
generating a complex signal from the adjusted viscosity signal;
obtaining a low frequency component of the filtered complex signal by filtering the complex signal into a high frequency component and the low frequency component and removing the high frequency component; and
determining the viscosity parameters from the low frequency component; and
selectively providing voltage to the viscometer based on the determined viscosity parameters.

17. The method of claim 16, wherein the acquiring the viscosity signal comprises applying a voltage to a wire of the viscometer and measuring a signal therefrom.

18. The method of claim 16, wherein the determined viscosity parameters comprise frequency and amplitude, the method further comprising selectively providing voltage to the viscometer at the determined frequency and amplitude.

19. The method of claim 16, wherein the determined viscosity parameters comprise frequency and decrement, and wherein the selectively providing comprises adjusting the acquiring the viscosity signal based on the determined frequency and decrement.
